(19) United States
(12) Patent Application Publication
(10) Pub. No.: US 2013/0016410 A1
(43) Pub. Date: Jan. 17, 2013

(54) OPTICAL DEVICE FOR AN ILLUMINATION DEVICE OF A 3D DISPLAY

(71) Applicant: Gerald Futterer, Dresden (DE)

(72) Inventor: Gerald Futterer, Dresden (DE)

(73) Assignee: SeeReal Technologies S.A., Munsbach (LU)

(21) Appl. No.: 13/548,424

(22) Filed: Jul. 13, 2012

(30) Foreign Application Priority Data
Jul. 14, 2011 (DE) 10 2011 079 127.2

(51) Int. Cl. G02B 27/22; G02B 5/32

(52) U.S. Cl. 359/15; 359/463

(57) ABSTRACT

An optical device for directing illuminating light at a pixel matrix and/or at a controllable spatial light modulator of a display, in particular of a stereoscopic or holographic 3D display comprises a multitude of reflection elements which work according to the principle of a concave mirror and which direct the illuminating light at the pixel matrix and/or at the controllable spatial light modulator of the display, and/or comprises at least one transmission element which is designed in the form of a holographic optical element, in particular in the form of a holographic volume grating, which directs the illuminating light at the pixel matrix and/or at the controllable spatial light modulator of the display.

### CROSS-REFERENCE TO RELATED APPLICATIONS

This application claims priority to German Application No. DE 10 2011 079 127.2, filed Jul. 14, 2011, the entire contents of which is hereby incorporated fully by reference.

### BACKGROUND OF THE INVENTION

The present invention relates to an optical device for directing illuminating light at a pixel matrix and/or at a controllable spatial light modulator of a display, in particular of a stereoscopic or holographic 3D display.

The present invention further relates to an illumination device, in particular a backlight unit, for a display and to a display, in particular a stereoscopic or holographic 3D display.

### FIELD OF THE INVENTION

A device for the holographic reconstruction of three-dimensional scenes is known from WO 2006/119920. That device comprises multiple light sources whose light is collimated by lenses and then directed at a spatial light modulator. Such a device has the disadvantage that its illumination unit requires much space. It is thus not possible to build a particularly thin display with that arrangement.

Further, a backlight unit to be used in a display is known from WO 2007/002796. The backlight unit comprises an aperture array which is inscribed into a reflective layer and a micro-lens array which is disposed in front of the former. However, that type of backlight also requires much space. Moreover, the portion of light which is not transmitted through the apertures of the aperture array is lost unused.

WO 2008/036640 discloses another type of backlight, where light-emitting diodes (LEDs) serve as light sources. The light-emitting diodes are attached to a transparent optical film which is disposed between a plane reflective surface and a light-emitting surface. That device has two major disadvantages: First, the emitted light is not collimated and, secondly, the light-emitting diodes shade a large portion of the reflective layer so that part of the emitted light is absorbed.

### SUMMARY OF THE INVENTION

It is thus the object of the present invention to provide an optical device which requires less space and which provides for a homogeneous illumination of a pixel matrix and/or of a spatial light modulator of a display, in particular of a 3D display, with collimated light.

The object is solved according to this invention by an optical device which is characterised by a multitude of reflection elements which work according to the principle of a concave mirror and which direct the illuminating light at the pixel matrix and/or at the controllable spatial light modulator of the display, and/or by at least one transmission element which is designed in the form of a holographic optical element (HOE), in particular in the form of a holographic volume grating, which directs the illuminating light at the pixel matrix and/or at the controllable spatial light modulator of the display preferably in a collimated manner.

The optical device according to this invention has the advantage that it can be manufactured such that it only requires very little space. Further preferably, this makes it possible to manufacture very thin illumination devices for displays and thus to make very flat displays.

In a preferred embodiment of the optical device according to this invention the reflection elements and/or the at least one transmission element are disposed side by side in a plane and/or in the form of a matrix. In particular, in a display according to this invention, it can preferably be provided that the pixels of the controllable spatial light modulator are arranged in groups that are arranged in the form of a matrix, where each reflection element and/or the at least one transmission element is assigned to one group of pixels.

In a particularly preferred embodiment of the optical device according to this invention, the reflection elements are designed in the form of concave mirrors, in particular in the form of parabolic mirrors. In particular, it can be provided that the reflection elements are designed in the form of astigmatic mirrors, in particular in the form of cylindrical mirrors. Such a construction is particularly preferable if elongated light sources such as optical fibres are used.

However, it is also possible that the reflection elements are designed in the form of spherical mirrors. Such a construction is particularly preferable if real or virtual point light sources or at least almost point-shaped light sources such as individual decoupling sites of optical fibres are used.

In an embodiment of the optical device according to this invention which can be manufactured easily multiple reflection elements and/or the at least one transmission element have a common substrate. Alternatively, however, it can be provided that each reflection element has an individual substrate.

In a particularly thin and robust embodiment, the optical device comprises a plate, in particular a transparent and/or clear glass or plastic plate which carries the reflection elements. Alternatively or additionally, the reflection elements can preferably be provided by way of embossing the plate with those structures, in particular in a hot stamping process.

For example, the reflection elements can be created by way of moulding them onto a plate, in particular onto a glass or plastic plate or by way of hot stamping of such a plate. Alternatively or additionally, it is also possible to make those structures by way of milling, e.g. using a diamond milling cutter.

In a particular embodiment of the optical device according to this invention, it is provided that the reflection elements comprise at least one, in particular transparent, substrate which comprises a reflective layer or which is coated with a reflective layer. Alternatively or additionally, it can preferably be provided that the reflection elements comprise at least one transparent substrate whose convex outer surface comprises a reflective layer or whose convex outer surface is coated with a reflective layer.

In a particularly preferred embodiment, which can be adapted very precisely to the optical boundary conditions of the actual application and which works very precisely, the reflection elements are designed in the form of holographic optical elements (HOE), in particular in the form of reflective volume holograms. According to the present invention, it can at least preferably be provided that the reflection elements comprise holographic optical elements (HOE), in particular reflective volume holograms. These embodiments have the particular advantage that a robust and space-saving layered design can be realised in a simple manner in an illumination device, in particular a backlight unit, and/or a display.

It can preferably be provided that the reflection elements comprise—at least in one opening direction—an aperture which is smaller than 5 mm, in particular smaller than 4 mm, very particularly smaller than 3 mm. In particular with 3D applications where the display is controlled according to the actual position of the observer's pupil, this has the advantage that possibly occurring diffraction artefacts are minimised so that they are not perceived by the observer. In this respect, it is essential to limit the spatial coherence to an absolutely necessary minimum in order to prevent coherent interference of light of neighbouring reflection elements or to minimise unwanted coherent superposition, such as cross-talking among individual pixels.

Further, to prevent disturbing artefacts such as speckle it can preferably be provided that the distance between neighbouring reflection elements and/or the distance between neighbouring transmission elements is greater than the coherence length of the illuminating light so to avoid coherent superposition of the light of neighbouring reflection elements and neighbouring transmission elements.

In a preferred embodiment of the optical device according to this invention, which allows a largely homogeneous illumination of a pixel matrix and/or of a controllable spatial light modulator, the reflection elements and/or the at least one transmission element are disposed such that they collimate the illuminating light. In an illumination device which is fitted with the optical device according to this invention, this can be realised for example in that at least one light source is disposed in a real or virtual focal point of a reflection element and/or transmission element. Alternatively or additionally, multiple light sources can preferably be provided of which at least one light source is disposed in a real or virtual focal point of a reflection element and/or transmission element.

As already mentioned above, the optical device according to this invention can preferably be used in an illumination device, in particular a backlight unit, for a display, in particular a stereoscopic or holographic 3D display.

In a preferred embodiment of such an illumination device, each reflection element and/or each transmission element is assigned with multiple light sources which are spaced apart from each other. Alternatively or additionally, it can preferably be provided that multiple light sources being spaced apart from each other are located in a real or virtual focal plane of each reflection element and/or of each transmission element respectively.

For example, multiple light waveguide structures can be disposed side by side or in an interleaved arrangement. Each reflection element or transmission element can for example be assigned with multiple light sources, e.g. three light sources, which are disposed at a little lateral distance to each other. It can in particular be provided that of these multiple light sources only—optionally—one is on. This provides the possibility to choose one of three different emission angles in a display, e.g. horizontally 0 degrees, −10 degrees and +10 degrees. This can for example preferably be used to support a tracking element, e.g. an LC grating, which is disposed behind a pixel matrix or behind a controllable spatial light modulator, i.e. an arrangement like that described as diffraction device in document WO 2010/149587 A2, and in particular to reduce the ‘angular load’ of such a tracking element.

In a preferred embodiment of an illumination device according to this invention, the light source comprises at least one light waveguide. It can in particular be provided that the light source comprises at least one light waveguide which runs through the real or virtual focal points of reflection elements which are disposed side by side in a row and/or of the transmission elements.

For example, it can be provided that a decoupling site of a light waveguide serves as light source and/or that each decoupling site of a multitude of decoupling sites of one or more light waveguides serves as a light source. A decoupling site can for example be formed by a discontinuity and/or indentation in the cladding of a light waveguide. As will be described in more detail below, it can alternatively or additionally be provided that an additional optical element, such as for example a holographic element and/or a holographic volume grating and/or a holographic lens serves as decoupling device. It is for example possible to take advantage of very small HOEs (e.g. 30 μm in diameter) as decoupling sites.

The light waveguide can preferably be provided in the form of an optical fibre, in particular in the form of a mono-mode fibre. Such an embodiment represents an almost ideal point or line light source (depending on the actual design of the decoupling). This preferably provides a large degree of collimation. Alternatively, it can be provided that the light waveguide is a planar light waveguide or that the light waveguide is of a stripe-shaped design. Such an embodiment is particularly preferred if a virtual point light source or a virtual line light source is to be generated, in particular if in a display a virtual point light source or a virtual line light source is to be located in front of a pixel matrix or in front of a controllable spatial light modulator, seen in the direction in which the observer looks at the display, which will be described in more detail below.

Such a design using light waveguides also allows a particularly preferred layered design of an illumination device and/or a display to be realised. Here, for example a multitude of light waveguides in parallel arrangement or a grid of light waveguides can preferably be provided.

In a particularly preferred illumination device, at least one optical element, in particular a holographic element and/or a holographic volume grating and/or a holographic lens and/or a Schmidt corrector plate, is disposed in the optical path between the light source and at least one of the reflection elements and/or between the light source and the reflective layer. Such an embodiment has the particular advantage of minimising disturbing diffraction effects which are for example caused by decoupling sites of a light waveguide.

In a very particularly preferred embodiment of the illumination device, the distance between neighbouring light sources which are assigned to neighbouring reflection elements and/or neighbouring transmission elements differs from the distance between the neighbouring reflection elements and/or neighbouring transmission elements themselves. Such a design can preferably render a field lens superfluous which would otherwise need to be disposed in front of the illumination device, in particular in front of a display which is fitted with such an illumination device, in order to direct the light which is emitted by the reflection elements and/or the transmission elements at a common point or into a specifiable region in the observer plane. For example, it can preferably be provided that the distance between neighbouring light sources increases gradually—preferably starting from the centre of the illumination device—towards the edges of the illumination device. In particular, it can be provided that the distance between neighbouring light sources increases gradually—preferably starting from the centre of the illumination device—towards the edges of the illumination device, while the distance between the assigned reflection elements and/or transmission elements remains constant or decreases. The effect described above can also be achieved in that the distance between neighbouring light sources increases—preferably starting from the centre of the illumination device—towards the edges of the illumination device more rapidly than the distance between the assigned reflection elements.

In an embodiment of an illumination device according to this invention which requires little space, it is provided that the optical element forms the light which is emitted by the light source such that it seemingly originates in a—in particular point—or line-shaped—virtual light source, which is located spaced apart from the (real) light source. It can in particular be provided that the—in particular plane, large-area—light source is disposed in the optical path of a virtual light source such that the light emitted by the light source seems to originate in the virtual light source. Such an embodiment provides the basis for making particularly thin illumination devices and/or particularly thin displays.

An embodiment which is particularly preferred in that context features an optical element that forms the light which is emitted by the light source such that it seemingly originates in a—in particular point- or line-shaped—virtual light source, which is located in the focal point or in a focal line of the reflection element.

In a particularly preferred embodiment, the optical element serves—in addition to other functions—as a decoupling device to couple out—in particular evanescent—light from a light waveguide. In particular, it can be provided that the optical element couples—in particular evanescent—light out of a light waveguide.

In another preferred embodiment of an illumination device according to this invention, the reflection elements and/or the at least one transmission element serve as decoupling devices for decoupling of—in particular evanescent—light from a light waveguide. In particular, it can be provided that the reflection elements and/or the at least one transmission element couples—in particular evanescent—light out of a light waveguide.

A display and/or 3D display, in particular a stereoscopic or holographic 3D display, with at least one of the aforementioned optical devices and/or with at least one of the aforementioned illumination devices is particularly preferred.

Such a display can preferably be of a layered design, where the optical device forms one layer and a controllable spatial light modulator and/or a pixel matrix forms another layer. Such an embodiment according to this invention can be very thin. Moreover, a layered design can ensure particular mechanical rigidity. A backlight unit according to this invention can for example comprise several layers—in particular of transparent materials. The layers which represent the individual components, including a pixel matrix and/or a controllable spatial light modulator can preferably be glued together to form a sandwich structure. This is a compact and rigid design.

For the sake of saving space, it can preferably be provided that the device is spatially disposed behind a controllable spatial light modulator and/or pixel matrix, seen from position of an observer who looks at the display, and that the display comprises at least one virtual light source which is spatially located in front of the controllable spatial light modulator and/or pixel matrix. In particular, it can for example be provided that an optical device according to the present invention including at least one optical element, in particular holographic element and/or holographic volume grating and/or holographic lens, which is disposed between a light source and the reflection element and/or between the light source and the reflective layer in the optical path, is spatially disposed behind a controllable spatial light modulator, seen in the viewing direction of the observer, and that the optical element forms the light which is emitted by the light source such that it seems to originate in a—in particular point- or line-shaped—virtual light source, which is spatially located in front of the controllable spatial light modulator.

### BRIEF DESCRIPTION OF THE DRAWINGS

The object of the present invention is shown schematically in the drawings. It will be described below with reference to the following Figures, where identical elements or elements with identical function are given identical reference symbols, where:

FIGS. 1 and 2 show an embodiment of a display according to this invention with a matrix of reflection elements,

FIG. 3 shows a detail of an embodiment of a display according to this invention,

FIG. 4 shows a different embodiment of a display according to this invention, where an optical element 10 is disposed between the light sources and the reflection elements,

FIG. 5 shows another embodiment of a display according to this invention with virtual light sources,

FIG. 6 shows another embodiment of a display according to this invention with virtual light sources which are located in front of the display,

FIG. 7 shows another embodiment of a display according to this invention with plane light waveguides,

FIG. 8 shows another embodiment of a display according to this invention with a reflection element in the form of a volume hologram, and

FIG. 9 shows a further embodiment of a display according to this invention with a transmission element.

### DETAILED DESCRIPTION OF THE INVENTION

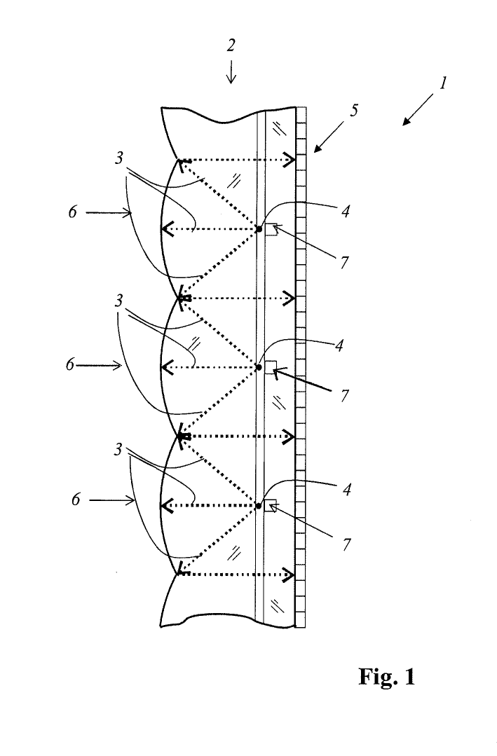

FIG. 1 shows a display 1 with an optical device 2 for directing illuminating light 3 which is emitted by multiple light sources 4 at a controllable spatial light modulator 5. The optical device 2 comprises a multitude of reflection elements 6 which work according to the principle of a concave mirror, namely parabolic mirrors, and which direct the illuminating light 3 at the controllable spatial light modulator 5 in a collimated manner.

Multiple decoupling sites where illuminating light 3 is coupled out of light waveguides 7, which run perpendicular to the drawing plane in FIG. 1, serve as light sources 4.

The backlight unit, which comprises mainly the optical device 1 and the light waveguides 7, can preferably be made of multiple layers of transparent materials which are glued together to form a sandwich structure. This is a compact and rigid design.

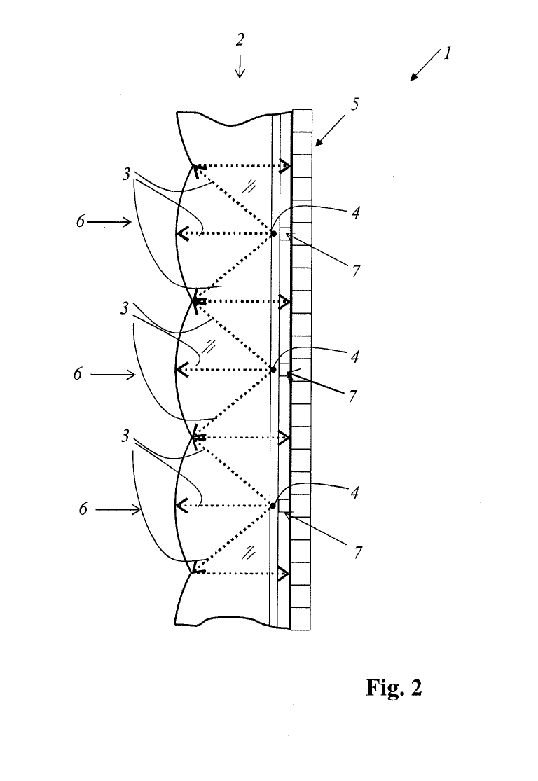

FIG. 2 shows another display 1 according to this invention with a matrix of reflection elements 6, where—in contrast to the display 1 shown in FIG. 1—the light waveguides are disposed immediately next to the controllable spatial light modulator 5.

The problem of the influence of possible diffraction at the light waveguide of the collimated illuminating light 3 which has already been coupled out and reflected by the reflection elements and which propagates towards the controllable spatial light modulator 5 is thereby substantially minimised.

The reduced distance to the controllable spatial light modulator 5 is shown in an idealised form in FIG. 2; it cannot be reduced to zero in practice. In order to make the propagation of an evanescent field possible in the light waveguide, a low refractive environment of the light waveguide is essential. However, the necessary layer thickness of a low-index material can be reduced to less than 2 μm. Light waveguide modes which correspond geometrically to a frustrated total internal reflection geometry are considered in this context. The field distribution outside the higher refractive light waveguide core is evanescent and would not be emitted without disturbing or desired effects.

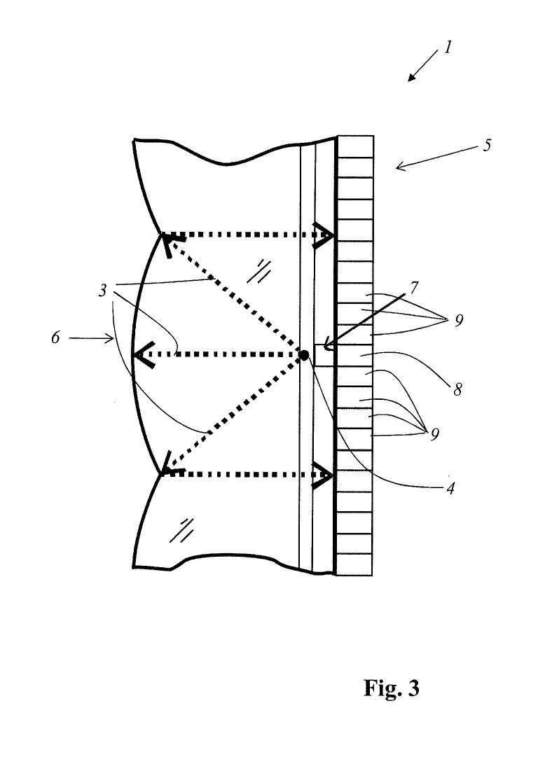

FIG. 3 shows a detail of a display 1 according to this invention.

Referring to the display 1 in FIG. 2, if the light waveguide 7 does not completely fill the free aperture or if it does not cover the entire cross-sectional area of the adjacent pixel 8 of the controllable spatial light modulator 5, then it must be expected that the phase profile which hits the pixel 8 is not plane. The constant phase offset relative to the other pixels 9, namely those in front of which there is no light waveguide 7, could be taken into account when encoding and addressing the controllable spatial light modulator 5.

The curvature of the phase profile across one pixel can also be minimised in that the light waveguide is designed such that it completely covers the free aperture of the adjacent pixel 8, as is shown in FIG. 3.

The width of the light waveguide 7 can also be chosen such that is covers the free aperture of multiple pixels, e.g. of three pixels (not shown in FIG. 3). This has the effect that the influence of the light waveguides which are not structured by decoupling sites can be compensated well. If the disturbing influence of the decoupling sites facing the controllable spatial light modulator 5 is too high, then the assigned pixels can be disabled (dead pixels).

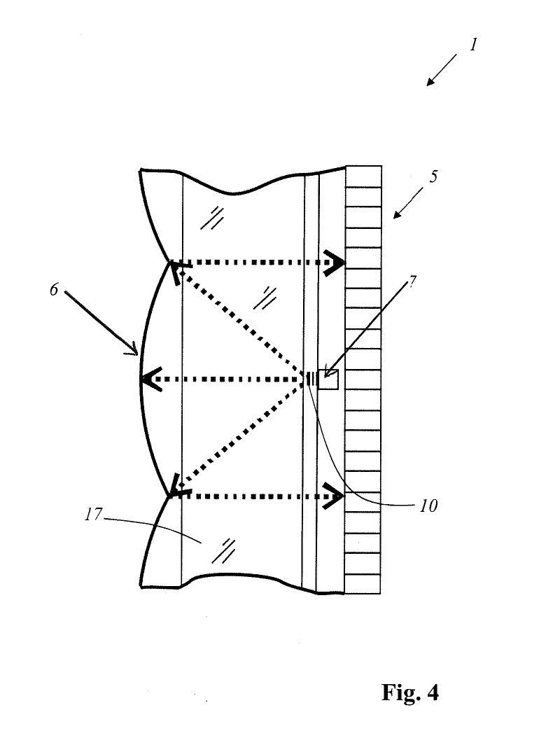

FIG. 4 shows an embodiment of a display 1, where an optical element 10, namely a holographic volume grating, is disposed between the light waveguide 7 and the reflection elements 6 in the optical path On the one hand, the optical element 10 serves as a decoupling device for coupling evanescent illuminating light 3 out of the light waveguide 7.

On the other hand, the optical element 10 effects a reduction of the influence of the decoupling sites on the collimated illuminating light which propagates from the reflection elements 6 towards the controllable spatial light modulator 5. Without the optical element 10, the decoupling sites would disturb the wave field of the collimated illuminating light and cause annular interference patterns. The optical element 10 can be a holographic decoupling site. These elements can preferably be volume holograms whose thickness can be chosen such that their angular selectivity is sufficiently low, so that the disturbing influence can be kept to a minimum.

The reflection elements 6 are embossed on a glass substrate 17.

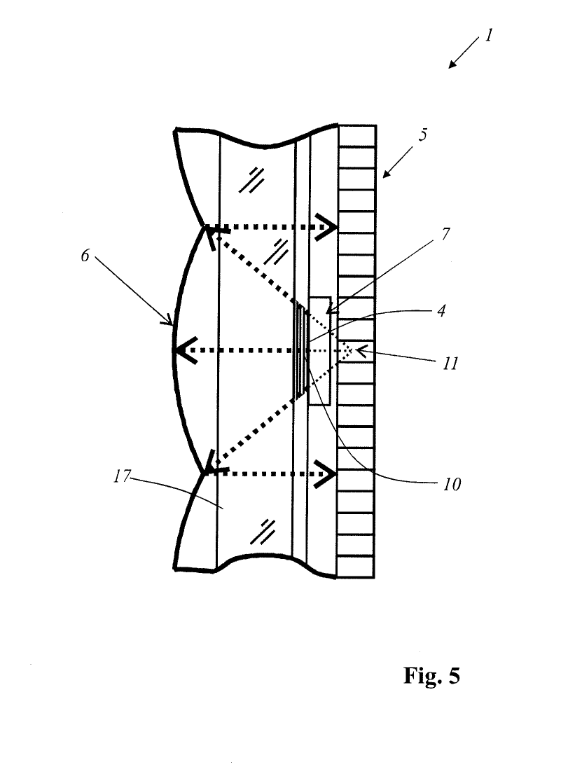

FIG. 5 shows an embodiment of a display 1, where, for the sake of further reducing the required space or depth of the display, the light which is emitted by the light source 4 is formed by the optical element 10 such that it seems to originate in a virtual light source 11 which is located at a spatial distance to the (real) light source 4, namely the decoupling site of the light waveguide 7. The light source 4 is thereby virtually dislocated towards the observer.

This preferably goes along with a growth in width of the light waveguide 7, which can be seen clearly in FIG. 5. This can be developed further into a plane waveguide which accommodates an in-situ exposed volume grating which emits the light centrally towards the reflection elements 6.

The optical element 10 can for example be created in-situ as a volume grating by way of superimposing a convergent spherical wave and the evanescent field of the light waveguide. Material which is characterised by negligible polymerisation shrinkage and great transparency is particularly well suited as holographic recording material.

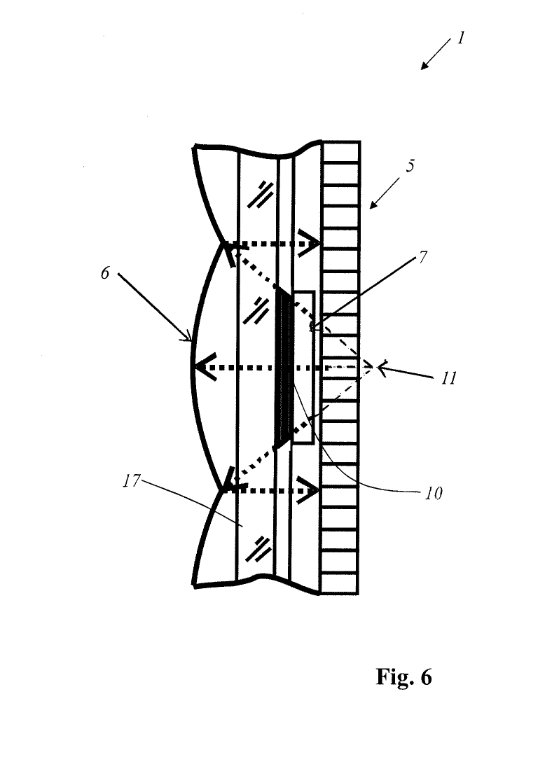

FIG. 6 shows a display 1, where the optical device 2 including the light waveguides 7 is spatially located behind the controllable spatial light modulator 5 (seen in the direction in which an observer looks at the display from a position on the right-hand side of the controllable spatial light modulator 5), and where the display 1 comprises at least virtual light sources 11 which are spatially located in front of the controllable spatial light modulator 5 and/or pixel matrix.

In this embodiment, the optical element 10 forms the illuminating light 3 which is emitted by the (real) light sources 4 such that it seems to originate in a virtual light source 11 which is spatially located in front of the controllable spatial light modulator 5.

In the embodiment shown in FIG. 6, the light initially propagates parallel in the light waveguide 7 and anti-parallel to the surface normal of the drawing plane. The optical element 10 serves for decoupling of the light and is designed in the form of a holographic lens, thus forming an off-axis lens. The refractive index variations which are necessary even for a diffraction efficiency q near 1 are small enough to generate holographic RGB multiplex lenses. RGB multiplex here means to perform one in-situ exposure per primary colour.

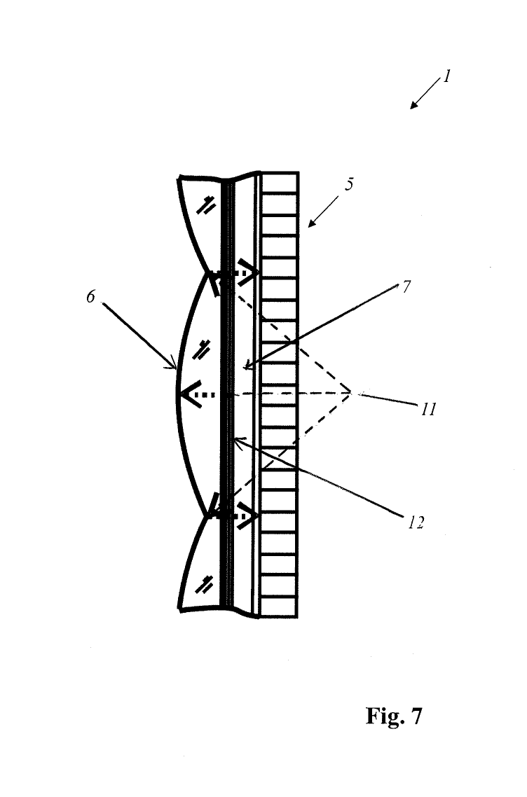

FIG. 7 shows another embodiment of a display 1 according to this invention, where, for the sake of further reducing the required space or depth of the display, a plane light waveguide 7 is used instead of a striped pattern or grid of multiple light waveguides, and where a plane, structured (bevelled) volume grating 12 is used as the optical element 10. In this embodiment, the virtual light source 11 is again located in front of the controllable spatial light modulator, seen from the position of the observer who looks at the display. The individual bevels of the structured volume grating 12 represent transmissive holographic off-axis lenses which for example have a diameter that—if the display 1 is a holographic 3D display—corresponds with the size of the largest possible sub-holograms.

The in-situ exposure of the optical element 10 can preferably be performed with the help of the evanescent field of the plane waveguide and the field of a spherical wave whose centre is located in the point of the virtual light sources 11. The matrix of reflection elements 6 and the controllable spatial light modulator 5 can then be attached. Each reflection element 6 is thus assigned with a transmissive holographic off-axis HOE as the optical element 10, which generates a spherical wave that is collimated, i.e. transformed into a plane wave, by each reflection element 6.

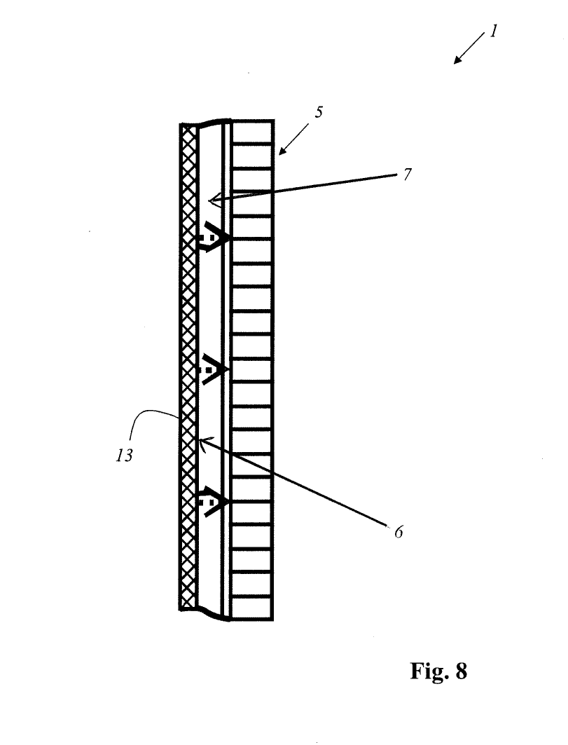

FIG. 8 shows another embodiment of a display 1 according to this invention with a reflection element 6 in the form of a plane, structured (bevelled) volume hologram 13.

Referring to the display 1 shown in FIG. 7, the decoupling direction can additionally be turned around towards the controllable spatial light modulator 5, so that the reflection element 6 is formed by a holographic element, for example a plane, structured (bevelled) volume hologram 13.

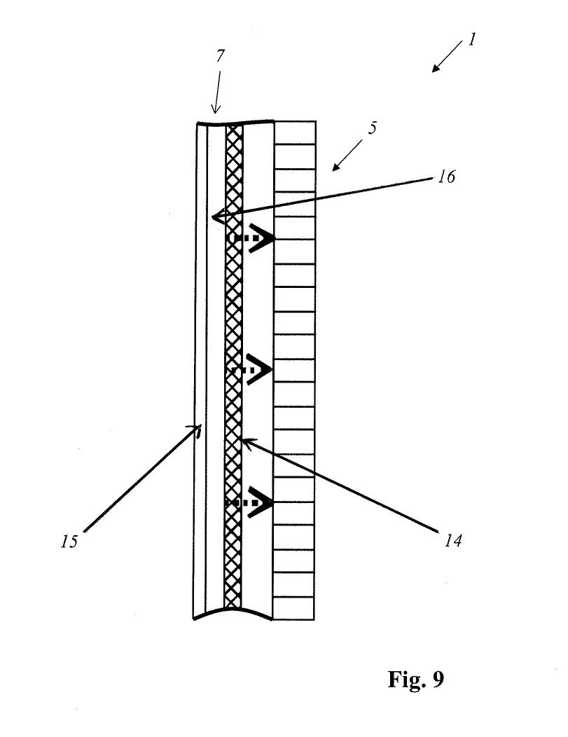

FIG. 9 shows another display 1 according to this invention with transmission elements 14 which are disposed between a plane light waveguide 7 and a controllable spatial light modulator 5. The light waveguide 7 comprises a cladding layer 15 and a core layer 16. The transmission elements 14 are designed in the form of a plane, structured (bevelled) holographic volume grating and couple evanescent light out of the light waveguide 7 and direct the illuminating light 3 at a controllable spatial light modulator 5. This display 1 is particularly thin. Generally, a single transmission element could be provided as well which would realise the same or comparable function.

The present invention has been described with reference to a particular embodiment. However, modifications and amendments hereto are of course thinkable without leaving the extent of protection as defined by the following claims.

1. An optical device for directing illuminating light at a pixel matrix and/or a controllable spatial light modulator of a display or, of a stereoscopic or holographic 3D display, wherein a multitude of reflection elements which work according to the principle of a concave mirror and which direct the illuminating light at the pixel matrix and/or at the controllable spatial light modulator of the display, and/or wherein at least one transmission element which is designed in the form of a holographic optical element, in particular in the form of a holographic volume grating, which directs the illuminating light at the pixel matrix and/or at the controllable spatial light modulator of the display.

2. An optical device according to claim 1, wherein the reflection elements and/or the at least one transmission element are disposed side by side in a plane and/or in the form of a matrix.

3. An optical device according to claim 1, wherein the reflection elements are designed in the form of concave mirrors or in the form of parabolic mirrors or in the form of astigmatic mirrors or in the form of cylindrical mirrors or in the form of spherical mirrors.

4. An optical device according to claim 1, wherein multiple reflection elements and/or the at least one transmission element have a common substrate or that each reflection element has an individual substrate.

5. An optical device according to claim 1, further comprising a plate, in particular a transparent and/or clear glass or plastic plate, where the plate carries the reflection elements and/or where the reflection elements are provided by way of embossing the plate with those structures, in particular in a hot stamping process.

6. An optical device according to claim 1, wherein the reflection elements comprise at least one substrate or at least one transparent substrate which comprises a reflective layer and/or that the reflection elements comprise at least one transparent substrate whose convex outer surface is coated with a reflective layer.

7. An optical device according to claim 1, wherein the reflection elements are designed in the form of holographic optical elements or in the form of reflective volume holograms, and/or in that reflection elements comprise holographic optical elements or reflective volume holograms.

8. An optical device according to claim 1, wherein the reflection elements comprise—at least in one opening direction—an aperture which is smaller than 5 mm or smaller than 4 mm or smaller than 3 mm.

9. An optical device according to claim 1, wherein the distance between neighbouring reflection elements and/or the distance between neighbouring transmission elements is greater than the coherence length of the illuminating light.

10. An optical device according to claim 1, wherein the reflection elements and/or the at least one transmission element collimate the illuminating light.

11. An Illumination device, in particular backlight unit, for a display or for a stereoscopic or holographic 3D display, comprising an optical device according to claim 1.

12. An Illumination device according to claim 11, further comprising at least one light source which is located in a real or virtual focal point of a reflection element and/or of a transmission element, and/or by multiple light sources of which at least one light source is located in a real or virtual focal point of a reflection element and/or of a transmission element, respectively.

13. An Illumination device according to claim 11, wherein each reflection element and/or each transmission element is assigned with multiple light sources being spaced apart from each other, and/or in that multiple light sources being spaced apart from each other are located in a real or virtual focal plane of each reflection element and/or of each transmission element respectively.

14. An Illumination device according to claim 12, wherein the light source comprises at least one light waveguide and/or in that the light source comprises at least one light waveguide which runs through the real or virtual focal points of reflection elements which are disposed side by side in a row and/or of the at least one transmission element.

15. An Illumination device according to claim 12, wherein a decoupling site of a light waveguide serves as light source and/or in that each decoupling site of a multitude of decoupling sites of one or more light waveguides serves as a light source, respectively.

16. An Illumination device according to claim 14, wherein the light waveguide is provided in the form of an optical fibre or in the form of a mono-mode fibre, or in that the light waveguide is provided in the form of a planar light waveguide or that the light waveguide is of a stripe-shaped design.

17. An Illumination device according to claim 11, wherein the distance between neighbouring light sources which are assigned to neighbouring reflection elements and/or neighbouring transmission elements differs from the distance between the neighbouring reflection elements and/or neighbouring transmission elements themselves.

18. An Illumination device according to claim 11, wherein
a. the distance between neighbouring light sources increases gradually—preferably starting from the centre of the illumination device—towards the edges of the illumination device and/or in that
b. the distance between neighbouring light sources increases gradually—preferably starting from the centre of the illumination device—towards the edges of the illumination device, while the distance between the assigned reflection elements and/or transmission elements remains constant or decreases and/or in that
c. the distance between neighbouring light sources increases—preferably starting from the centre of the illumination device—towards the edges of the illumination device more rapidly than the distance between the assigned reflection elements.

19. An Illumination device according to claim 11, wherein at least one optical element or a holographic element and/or a holographic volume grating and/or a holographic lens and/or a Schmidt corrector plate, is disposed in the optical path between the light source and at least one of the reflection elements and/or between the light source and the reflective layer.

20. An Illumination device according to claim 19, wherein
a. the optical element forms the light which is emitted by the light source such that it seemingly originates in a—in particular point- or line-shaped—virtual light source which is spaced apart from the (real) light source and/or in that
b. the optical element forms the light which is emitted by the light source such that it seemingly originates in a—in particular point- or line-shaped—virtual light source which is located in the focal point or in a focal line of the reflection element.

21. An Illumination device according to claim 19, wherein the optical element serves as a decoupling device to couple out—in particular evanescent—light from a light waveguide and/or that the optical element couples—in particular evanescent—light out of a light waveguide.

22. An Illumination device according to claim 19, wherein the reflection elements and/or the at least one transmission element serve as decoupling device to couple out—in particular evanescent—light from a light waveguide and/or in that the reflection elements and/or the at least one transmission element couple—in particular evanescent—light out of a light waveguide.

23. A display and/or 3D display, in particular stereoscopic or holographic 3D display, with an optical device according to claim 1 and/or with an illumination device according claim 11.

24. A display according to claim 23, comprising a layered design, where the optical device forms one layer and a controllable spatial light modulator and/or a pixel matrix forms another layer.

25. A display according to claim 23, wherein the optical device is spatially disposed behind a controllable spatial light modulator and/or a pixel matrix and in that the display comprises at least one virtual light source which is spatially located in front of the controllable spatial light modulator and/or the pixel matrix.
